(19) United States
(12) Patent Application Publication
(10) Pub. No.: US 2008/0078961 A1
(43) Pub. Date: Apr. 3, 2008

(54) Method and Device for Modifying the Deexcitation Probability of Nuclear Isomers

(76) Inventors: Robert Desbrandes, Givarlais (FR); Daniel Lee Van Gent, Baton Rouge, LA (US)

Correspondence Address: E-QUANTIC COMMUNICATIONS, 1, ALLEE DES CHERINIERS, GIVARLAIS, FR-03190, omitted

(21) Appl. No.: 10/599,555

(22) PCT Filed: Mar. 27, 2005
(86) PCT No.: PCT/EP05/51404

§ 371 Date: Oct. 1, 2006

(30) Foreign Application Priority Data
Apr. 13, 2004 (FR) 0403905

(51) Int. Cl. G21K 1/00

(52) U.S. Cl. 250/505.1

(57) ABSTRACT

The invention relates to a method and device for modifying the probability of deexcitation in relation to isomer nuclides, consisting in exciting samples containing nuclides having a metastable state with a half-life varying between one microsecond and 50 years. The excitation is achieved by irradiation with entangled gamma rays produced either by a radioactive isotope, which emits a gamma-ray cascade, or by collisions between accelerated particles and a target, caused by the Bremsstrahlung effect. According to Quantum Mechanics, the gamma-rays produced are entangled, and said entanglement is transferred to the nuclei of the isomer nuclides. As a result, each isomer of the radioactive product obtained has a half-life, which can vary over time and which is initially lower than the theoretical half-life thereof. The inventive device comprises an entangled gamma source and a device for sequentially irradiating one or more samples over a duration, which is determined as a function of the half-life modification to be obtained. The method and device are particularly suitable for medical treatments and chemical engineering applications.

### TECHNICAL FIELD

The present invention relates to a method and an equipment to modify the probability of deexcitation of isomer nuclides.

The probability of deexcitation of a radioactive element is related to the half-life, i.e. time necessary to the deexcitation of half of the radioactive nuclei. This probability is given the formula:

P=LN(2)/λ
P, probability of deexcitation per minutes;
LN, natural logarithm;
λ, half-life in minutes.

For example, the half-life of normal indium 115^{m} is 268 minutes. The probability of deexcitation per minute of a nucleus is thus 0.00258, which represents one chance on 387 per minute. By normal indium 115^{m}, one indicates that the isomer is excited classically and not as stipulated in this invention.

There are many nuclides that have a metastable state (isomers) whose half-life goes, according to isomers, from one microsecond or less to 50 years or more. A list of main isomers is given in Table 1. In this table are listed the symbol, the abundance of the isotope, the half-life of the nuclei, and the energy of the gamma radiation emitted at the time of the deexcitation. Indium 115, for example, has a 268 minutes (4.48 hours) metastable state with the half-life shown in FIG. 1. It returns to its stable fundamental state by isomeric transition while emitting a gamma radiation from 336.2 keV. The isomeric transition, like internal conversion, does not give place to a change of atomic number. In its normal state, an isomer returns in its ground state with the half-life mentioned in Table 1. Certain isomer nuclei, like Hafnium 178, or Hafnium 179, emit several gamma at the time of their return to the ground state. There also exist many radioactive isotopes with a metastable state, which can be used in applications of the invention.

The invention, whose implementation is described in the continuation, exploits properties anticipated by Quantum Mechanics according to which, two or several entangled particles keep a quantum coupling when they are separated by any distance, quantum coupling which is instantaneous in the same reference frame. According to these properties, the deexcitation of one of the particles would cause the deexcitation of the other or others. These properties until now implemented with microscopic particles, have just been implemented with macroscopic systems.

The following references of the literature are quoted below:
[1.] Einstein A., Podolsky B., Rosen N., Phys. Rev. 47, 777, (1935)
[2.] Collins C. B., Proceedings of the First International Induced Gamma Emission Workshop IGE '97, edited by I. I. Popescu and C. A. Ur (IGE Foundation, Bucharest, Romania, 1999), pp. 1-17.Ch.
[3.] Silberhorn, et al. Physical Review Letters, 86, 19, pp. 4267-4270, 7 May 2001.
[4.] Ikoro N. C., Johnson D. A., and Antich P. P., Med. Phys. 14, 93,1987.
[5.] Natto S. S. A, Journal of Australian Physical & Engineering Sciences in Medecine, 26, 3, pp 78-82,2003.
[6.] Bertlmann R. A., and Zeilinger A., (eds) <<Quantum [Un]speakables, from Bell to Quantum Information>>, Springer-Verlag Heidelberg, 2002.
[7.] Julsgaard B., Kozhekin A., and Polzik E. S., <<Experimental long-lived entanglement of two macroscopic objects>>, Nature, 413, 400-403, (2001).

### BACKGROUND OF THE INVENTION

The radioactive elements have a rigorously constant half-life within the limits of the statistical fluctuations. Besides the case of isomers irradiated according to the methods described in the present invention or stimulation with x-rays or gamma of excited isomer nuclei, it is impossible to vary the half-life of a radioactive isomer.

### BRIEF SUMMARY OF THE INVENTION

The invention makes use of entangled gamma rays to excite one or more isomer nuclides, for example those listed in Table 1. These entangled gamma rays come from nuclear reactions such as the disintegration of Cobalt 60 or the phenomenon of Bremsstrahlung in particle accelerators. The entanglement of the produced gamma rays is transferred to the isomer nuclides. The radioactive products obtained then, have a variable half-life, which is due to the coupling between the entangled nuclides.

It is known to the experts that the deexcitation of isomer can be accelerated by irradiation X or gamma (sometimes called stimulation X or gamma stimulation). On the other hand, in this invention the half-life of produced isomer changes with time without the intervention of an irradiation. In addition, the half-life obtained within the framework of the invention, varies in time, being shorter at the beginning of the life of isomer, and longer thereafter as shown in FIG. 5 in the example of Indium 115^{m}.

In this invention, the excited isomer samples are not stimulated. The variation of the half-life results from the method of entanglement of the atomic nuclei.

This invention solves a technical problem by providing a radioactive element with a variable half-life without stimulation and adaptable for a given application. In general the excited isomer product obtained by the method is characterized by an initial half-life ranging between 10% and 100% of the theoretical half-life according to the level and the nature of the entanglement.

The probability of disintegration or deexcitation of a radioactive element is not modified by a change of its physical or chemical state. Consequently, the excited samples with the techniques described in this invention can be transformed by fusion, vaporization, dissolution or chemical combination after irradiation without modification of their nuclear properties.

Several isotopes can exist naturally or be incorporated artificially in the samples. These samples can then be alloys or mixtures of several isotopes having a metastable state. In this case, the half-life of each excited isotope, according to the invention, can be measured simultaneously with a gamma spectrograph known to the expert.

The method according to the invention consists in irradiating, using entangled gamma rays, a sample of an element or several elements having a duration of half-life of the metastable states, going from one microsecond to 50 years. The radiation source can be either a radioactive isotope, which produces entangled gamma rays, or a particle accelerator, using particles such as electrons, alpha particles, or protons, which by Bremsstrahlung effect produce entangled gamma rays.

In the case of the radioactive source, the gamma rays must be emitted in a cascade by the same nucleus to be entangled, and the energy of the gamma rays must be higher than the threshold of excitation of the selected isomer. For example, an emission in a cascade is provided by Cobalt 60, as shown in FIG. 2. The entangled gamma rays must have a sufficient energy to cause a reverse isomeric transition of the irradiated isomer, i.e. to make the nuclei of the isomer pass from their ground state to their metastable state. In the case of Indium 115, for example, the necessary energy is of 1,080 keV, condition, which is met by the two gamma rays of Cobalt 60. One sees in FIG. 2, that one of gamma has an energy of 1,173 keV with 99.90% chance to occur, and the other 1,332 keV with 99,98% chance to occur. A cascade thus happens, because the two gamma are emitted with a 0.713 picosecond (10⁻¹² second) interval on average.

In the case of an irradiation by the Bremsstrahlung gamma rays produced by a particle accelerator, for example with electrons, the energy of gamma must again be higher than the threshold of excitation of the selected isomer.

For example, a compact linear accelerator can emit a gamma radiation very focused with a spectrum of gamma energy from 0 to 6 MeV. This spectrum is shown on FIG. 3. The energy of all the electrons before hitting the tungsten target is 6 MeV. Consequently, each electron emits on average four gamma of 1.5 MeV (1500 keV) as shown in FIG. 3 in a very fast succession comparable to a cascade. The emitted gamma rays are thus entangled by two, three or four. The cascade of gamma thus obtained with the compact linear accelerator is, as the experiment shows, more efficient to modify the half-life than the source of Cobalt 60.

### BRIEF DESCRIPTION OF DRAWINGS

FIG. 1 represents the energy levels of the Indium 115 nucleus during its excitation in a metastable state. The half-life of this state is normally 4.486 hours, the energy of the emitted gamma ray is of 336.24 keV (“Table off Isotopes”, CD-ROM, 8th edition, Version 1.0, Richard B. Firestone, Laurence Berkeley National Laboratory, University of California).

FIG. 2 represents the transition from the Cobalt 60 nucleus towards Nickel 60. The cascade, which has 99.9% chances to occur, emits two entangled gamma rays with 1173.237 keV and 1332.501 keV respectively (“Table off Isotopes”, CD-ROM, 8th edition, Version 1.0, Richard B. Firestone, Laurence Berkeley National Laboratory, University off California).

FIG. 3 represents the spectra of energy of the electrons in the accelerator and the gamma rays emitted by the target. Maximum for 1.5 MeV energy (Sameer S. A. Natto, Journal off Australian Physical & Engineering Sciences in Medicine, 26, 3, p 78-82, 2003).

FIG. 4 illustrates a mode of implementation of the invention with a radioactive source and a plurality of samples.

FIG. 5 represents a typical variation of the half-life of a sample irradiated according to the invention with a radioactive source.

FIG. 6 illustrates a mode of implementation of the invention with a particle accelerator and a plurality of samples.

FIG. 7 represents a typical variation of the half-life of a sample irradiated according to the invention with a particle accelerator.

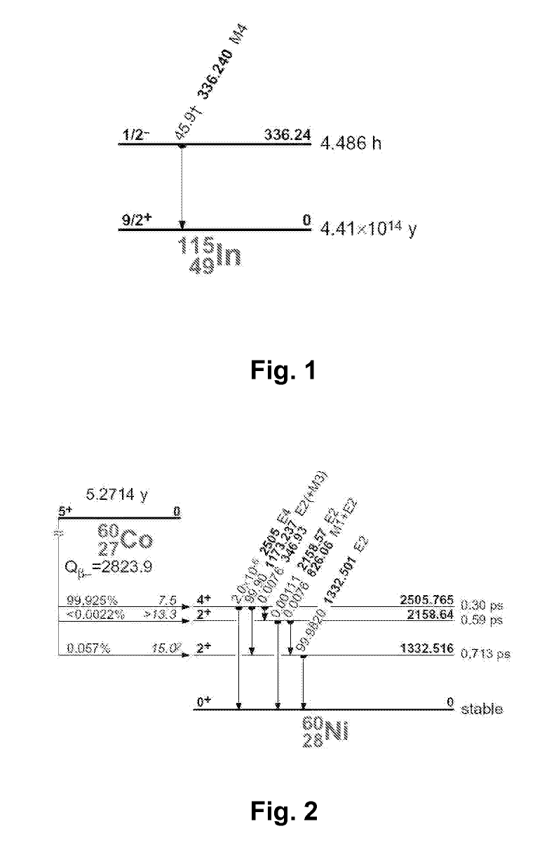

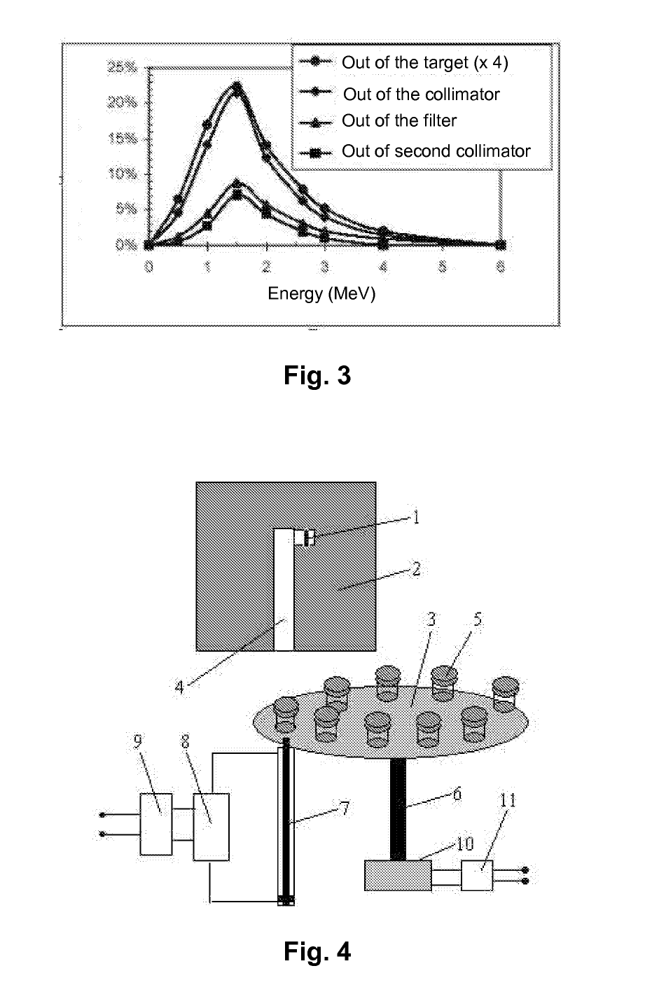

Table 1 is a list of the main nuclear nuclei having a metastable state with their symbol, abundance, half-life and gamma rays emission.

### MODES FOR CARRYING OUT THE INVENTION

Manners of implementing the invention are described below. However it is specified that the present invention can be implemented various ways. Thus, the specific details mentioned below should not be understood as limiting the implementation, but rather as a descriptive base to support the claims and to teach the experts of the profession the use of the present invention, in practically all the detailed and usable systems, structures, or manners.

According to a particular mode of the invention, the samples to be irradiated are placed on a tray (3), which presents samples (5) in succession in front of a piston (7), which introduces them opposite a radioactive source (1) by the opening (4) as shown in FIG. 4. The source is placed in a thick steel and lead shielding (2). An axis (6) connects the tray to a motor (10) controlled by a timer (11). The time of irradiation is adjusted for each sample using a timer (9), which actuates a pneumatic valve (8) to obtain the optimal response of activation.

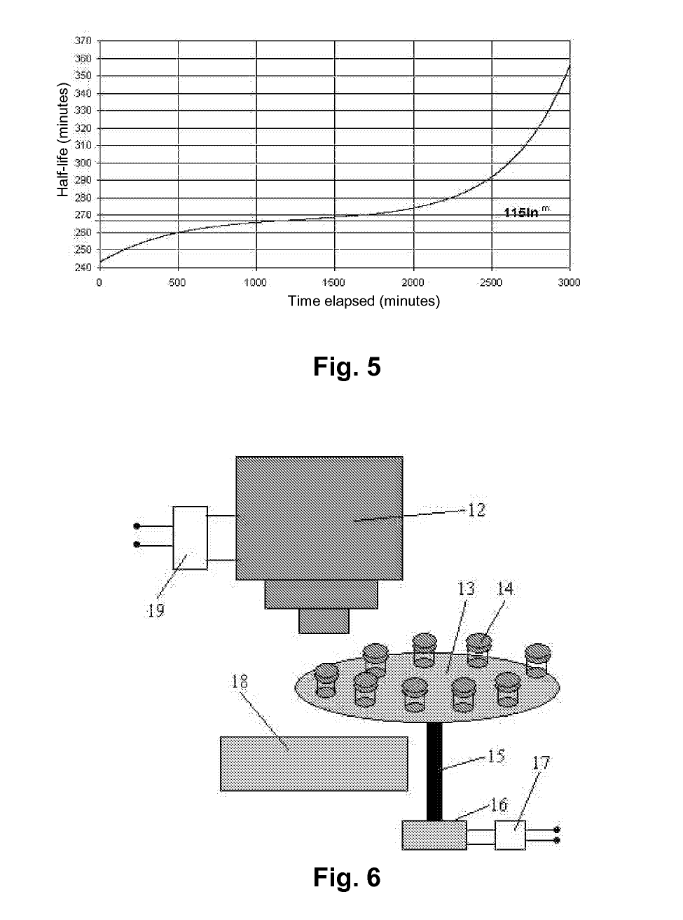

In the case, for example, Indium 115, a 20 hours irradiation with a source of 111,000 GBq (3,000 Ci) of Cobalt 60 produces Indium isomer In115^{m} with an initial half-life of 242 minutes instead of 268 minutes, which is the half-life of normal isomer, which is a reduction of 10%. This reduction can be modified by varying the time of irradiation. Contrary to a normal isomer, after 1500 minutes of elapsed time, the half-life exceeds the normal half-life is 268 minutes to reach 360 minutes after 3000 minutes of elapsed time. The sample thus remains slightly radioactive for a very long time. FIG. 5 schematically shows the evolution of the half-life for an irradiated Indium sample, In 115^{m}, under the preceding conditions.

According to another mode of implementation of the invention, schematized on FIG. 6, the samples (14) are placed on a rotating tray (13). This tray is supported by an axis (15) and is connected to a motor (16), which is controlled by a timer (17). The samples are presented in a sequence in front of the beam of X-rays of a compact linear accelerator (12) for example. A “phantom” (18) filled with water stops the non-absorbed gamma rays. In general the accelerators cannot function permanently. A certain number of units of time of irradiation, for example units of 5 minutes, is applied to each sample according to the desired initial half-life using a timer (19).

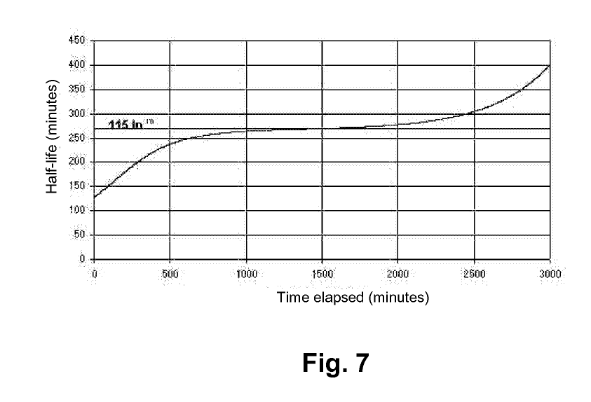

The accelerator emits a focused radiation, contrary to the source of Cobalt 60. Moreover, with the gamma rays emitted by the target of an accelerator, up to four gamma with a sufficient energy to activate the nuclei such as the Indium 115 nuclei are produced in a cascade. This radiation is thus more efficient and a short time of irradiation is generally sufficient. FIG. 7 represents the diagrammatic evolution of the half-life of an Indium 115 sample that was exposed to the radiation of a compact linear accelerator during 20 minutes. The initial half-life 130 minutes is compared with 268 minutes for the regular In 115^{m}, that is to say a reduction of 50%. Again the normal half-life is reached after 1,500 minutes have elapsed and grows then to 400 minutes when the time reaches an elapsed 3,000 minutes.

The pieces of equipment described previously are examples of implementation. Other means to present the samples to the irradiation can be employed without leaving the framework of the invention.

The samples to be irradiated are solids in sheet or powder, fluids or gases (case of Xenon for example), which contain proportions of one or several isotopes of Table 1 and/or radioactive isotopes that have a metastable state. The samples can also be alloys, mixtures, or chemical compounds incorporating proportions of one or several isotopes of Table 1 and/or radioactive isotopes that have a metastable state. The samples can also be transformed physically or chemically after irradiation. For example a sample in the form of powder or of gas can be incorporated in injectable carrying molecules.

Measurements of half-life can be taken with the conventional instruments of the experts. The gamma spectroscopes used at present contain thousands of channels to simultaneously measure the response of hundreds of radioactive or excited isotopes.

A common instrument is the detector with germanium crystals functioning at low temperature. In order to minimize the effects of the cosmic rays, radon, and the ambient interferences, the samples can be placed in an enclosure with walls of copper, lead and steel. An analyzer is set on the characteristic radiations of the selected isomers. For example, in the case of Indium 115^{m}, the gamma rays are counted in line 336 keV; in the case of Hafnium 179, 25 days of half-life, many lines are detectable. The main ones are 453, 409, 362, 315, 268 and 122 keV. These lines are emitted in a cascade with picoseconds of interval and are easily detected by the germanium crystal spectrographs. It is also possible that progress of the technique makes it possible to measure the lines without a special enclosure.

### INDUSTRIAL APPLICABILITY

Various industrial or medical applications are possible. A chemical reaction for example can require a strong dose of radiation at the beginning (higher than the dose of radiation of the same not entangled isomer isotopes), which is followed by a weaker dose lasting for a long time. It is the same for a medical processing which requires an evolution of the doses in time. The use of several isotopes in the same sample is used to simultaneously have gamma rays of various energies during the deexcitation of the excited isomer isotopes.

TABLE 1

| Nuclide | Symbol | Abundance % | Half-life | | Gamma keV |
|---|---|---|---|---|---|
| Niobium | 93Nb41 | 100 | 16.3 | y | 31.8 |
| Cadmium | 111Cd48 | 12.8 | 48.54 | m | 396.2 |
| Cadmium | 113Cd48 | 12.2 | 14.1 | y | 263.5 |
| Cesium | 135Ce | — | 53 | m | 846/786 |
| Indium | 115In49 | 95.7 | 4.48 | h | 336.2 |
| Tin | 117Sn50 | 7.7 | 13.6 | y | 314.6 |
| Tin | 119Sn50 | 8.6 | 293 | d | 60.5 |
| Tellurium | 125Te52 | 7.1 | 57.4 | d | 144.8 |
| Xenon | 129Xe54 | 26.5 | 8.8 | d | 238.1 |
| Xenon | 131Xe54 | 21.2 | 11.8 | d | 163.9 |
| Hafnium | 178Hf72 | 27.3 | 31 | y | 574/ . . . /93 |
| Hafnium | 179Hf72 | 13.6 | 25 | d | 453/ . . . /122 |
| Iridium | 193Ir77 | 62.7 | 10.5 | d | 80.2 |
| Platinum | 195Pt78 | 33.8 | 4 | d | 259.3 |

m: minutes,
h: hours,
d: days,
y: years.

1) Product consisting in a sample containing at least one kind of excited isomer nuclides in which at least one said excited isomer nuclide has at least one metastable state that deexcites by emitting gamma rays, called hereafter deexcitation gamma rays, characterized:
(a) in that groups of two or several excited nuclei of the aforesaid excited isomer nuclides of the aforesaid sample, are entangled between them, the aforementioned sample being called thereafter by convention the “entangled” sample, and presenting quantum coupling between some of the excited nuclei of the aforesaid excited isomer nuclides,
(b) and, in that the measurable half-life, called thereafter the “variable” half-life, on at least one said excited isomer nuclide of said “entangled” sample, during its natural deexcitation producing said deexcitation gamma rays, is variable, due to the quantum coupling between said entangled excited nuclei of the aforesaid nuclide, the initial said “variable” half-life of the aforesaid excited isomer nuclide being strictly lower than the constant half-life of the said excited isomer nuclide given by the table of isotopes, said constant half-life thereafter being called the theoretical half-life of the aforesaid excited isomer nuclide, and the value of the said “variable” half-life of the aforesaid excited isomer nuclide varying from the value of the said initial “variable” half-life to the value of the said theoretical half-life of the aforesaid excited isomer nuclide, then increasing beyond the value of the aforesaid theoretical half-life.

2) Product according to claim 1 further characterized in that said “entangled” sample comprises said excited nuclei of at least one kind of said isomer nuclides having at least one said metastable state with a duration of its theoretical half-life from one microsecond to 50 years, for example, Niobium (93Nb41m), Cadmium (111Cd48m), Cadmium (113Cd48m), Cesium (135Ce55m), Indium (1151n49m), Tin (117Sn50m), Tin (119Sn50m), Tellurium (125Te52m), Xenon (129Xe54m), Xenon (131Xe54m), Hafnium (178Hf72m), Hafnium (179Hf72m), Iridium (1931r77m), or Platinum (195Pt78m).

3) Product according to claim 1 further characterized in that said “entangled” sample comprises said excited nuclei of at least one kind of said excited isomer nuclides being radioactive isotopes.

4) Product according to claim 1 further characterized in that said “entangled” sample, comprising said excited nuclei, is in any physical or any chemical form, for example in the form of solid in sheet or powder, or in the form of fluid or gas (case of Xenon for example), said “entangled” sample containing a proportion of at least one or several aforesaid excited isomer nuclides, for example, Niobium (93Nb41m), Cadmium (111Cd48m), Cadmium (113Cd48m), Cesium (135Ce55m), Indium (1151n49m), Tin (117Sn50m), Tin (119Sn50m), Tellurium (125Te52m), Xenon (129Xe54m), Xenon (131Xe54m), Hafnium (178Hf72m), Hafnium (179Hf72m), Iridium (193Ir77m), Platinum (195Pt78m).

5) Product according to claim 1 further characterized in that said “entangled” sample, comprising said excited nuclei, is in the form of alloys, mixtures, or chemical compounds incorporating a proportion of said excited nuclei from one or several aforesaid excited isomer nuclides.

6) Product according to claim 1 further characterized in that said “entangled” sample underwent a physical and/or a chemical transformation after its manufacture.

7) Product according to claim 1 further characterized in that said initial “variable” half-life of at least one of the aforesaid excited isomer nuclides of the “entangled” sample is strictly lower than the theoretical half-life of the aforesaid excited isomer nuclide, for example ranging between 10% and 90% of the theoretical half-life.

8) Product according to claim 1 further characterized in that said “entangled” sample contains said excited nuclei from at least two said excited isomer nuclides.

9) Product according to claim 1 further characterized in that said “entangled” sample contains said excited nuclei from at least one excited isomer nuclide in at least two said metastable states.

10) Manufacturing process of the product according to claim 1 in which one uses amongst other things:
(a) at least one kind of said isomer nuclide having at least one said metastable state,
(b) irradiation by gamma rays,
characterized in that one prepares a sample containing nuclei of at least one said isomer nuclide having at least one said metastable state, by irradiation by means of gamma rays comprising at least some groups of entangled gamma rays, of a sufficient energy to excite certain of the aforesaid nuclei of the said isomer nuclide in at least one said metastable state, the aforementioned entangled gamma rays being generated, for example, either by a source of gamma rays emitted in a cascade, or by a generator of gamma rays coming from the Bremsstrahlung of accelerated particles, such as electrons, alpha particles, or protons, the aforementioned groups of entangled gamma rays exciting the aforementioned corresponding nuclei of the aforesaid isomer nuclide distributed in the aforementioned irradiated sample that is produced, qualified in the continuation by convention “entangled” sample.

11) Method according to claim 10 further characterized in that the said initial “variable” half-life of the obtained aforesaid “entangled” sample varies with the duration of said irradiation and/or with the power of said irradiation.

12) Use of the product according to claim 1 characterized in that one employs the aforementioned deexcitation gamma radiation, emitted by natural deexcitation of the aforementioned “entangled” sample, as a source initially emitting a high dose of radiation, then a decreasing dose, and followed by a low dose of radiation for a long time, to irradiate the environment of the said “entangled” sample.

13) Use according to claim 12 further characterized in that the aforesaid “entangled” sample deexcitation gamma radiation is used to conduct one or more physicochemical reactions.

14) Use according to claim 12 further characterized in that one employs the aforesaid “entangled” sample in the form of a solution.

15) Use according to claim 12 further characterized in that one employs the aforesaid “entangled” sample after having undergone a physical transformation or a chemical conversion following its manufacture.

16) Use according to claim 12 further characterized in that the aforementioned deexcitation gamma radiation comprises at least two lines of different energies emitted by at least two aforesaid excited isomer nuclides to irradiate the environment of said “entangled” sample.

17) Use according to claim 12 further characterized in that the aforementioned deexcitation gamma radiation comprises at least two lines of different energies emitted by the same aforesaid excited isomer nuclide to irradiate the environment of said “entangled” sample.

18) Use according to claim 12 further characterized for a medical treatment.
